(19) United States
(12) Patent Application Publication
(10) Pub. No.: US 2011/0110575 A1
(43) Pub. Date: May 12, 2011

(54) DENTAL CARIES DETECTOR

(75) Inventors: A. Banumathi, Tamilnadu (IN); S. Raju, Tamilnadu (IN); V. Abhaikumar, Tamilnadu (IN)

(73) Assignee: THIAGARAJAR COLLEGE OF ENGINEERING, Tamilnadu (IN)

(21) Appl. No.: 12/647,119

(22) Filed: Dec. 24, 2009

(30) Foreign Application Priority Data
Nov. 11, 2009 (IN) 2760/CHE/2009

(51) Int. Cl. G06K 9/62

(52) U.S. Cl. 382/132; 382/128

(57) ABSTRACT

Briefly, in accordance with one aspect, a method for detecting caries on a tooth is provided. The method includes clustering image pixels of an edge-enhanced image of the tooth to identify enamel, dentine, pulp and caries layers of the tooth and determining a plurality of texture parameters for each of the identified enamel, dentine, pulp and caries layers. The method also includes comparing the plurality of texture parameters with reference parameters to detect caries on the tooth.

### CROSS REFERENCE TO RELATED APPLICATIONS

This application claims priority to Indian Patent Application Serial No. 2760/CHE/2009 filed Nov. 11, 2009, the contents of which are incorporated by reference herein in its entirety.

### BACKGROUND

Dental caries, also known as tooth decay or cavity, is a bacterial disease that occurs on any surface of a tooth that is exposed to the oral cavity. Caries are generally described by their location on tooth surfaces. The location of facial caries is described as buccal when found on the surfaces of posterior teeth opposing the cheeks and as labial when found on the surfaces of anterior teeth opposing the lips. Occlusal caries are found on the chewing surfaces, and lingual caries on surfaces facing the tongue.

Traditional diagnosis of caries involves inspection of visible tooth surfaces using a light source. Large dental caries are often apparent to the naked eye, but smaller lesions and lesions in early stages are difficult to identify. Further, occlusal and inter proximal caries associated with the existing restorations are much more complicated to detect with clinical examination.

Typically, a patient is periodically examined using dental radiography to monitor progression of dental caries. A radiograph may be employed to analyze different layers of the tooth to detect the caries on the tooth. Intra oral views, bitewing views and orthopantomography are commonly used radiographs in detection of dental caries. Dental radiographs, obtained using X-rays that are shot through the jaw and picked up on film, may show some cavities before they are visible to the eye. Further, the dentist may assess the extent of the caries lesion using a dental probe. Subsequently, a thermal test may be performed using electric pulp tester to find whether the pulp is affected by the caries or not.

However, detection using such techniques is usually subjective and may vary in accuracy due to factors such as viewing conditions and dentist expertise, among others. Such techniques are not capable of clinically identifying the abnormalities when the carious lesions are thin or the intrusion of the caries into the pulp is sharp. Further, such systems are not capable of providing other details such as thickness of the enamel and other layers of the tooth and involvement of caries in the respective layers.

### SUMMARY

Briefly, in accordance with one aspect, a method for detecting caries on a tooth is provided. The method includes clustering image pixels of an edge-enhanced image of the tooth to identify enamel, dentine, pulp and caries layers of the tooth and determining a plurality of texture parameters for each of the identified enamel, dentine, pulp and caries layers. The method also includes comparing the plurality of texture parameters with reference parameters to detect caries on the tooth.

In accordance with another aspect, a method for detecting caries on a tooth is provided. The method includes accessing a radiographic image of the tooth and high-pass filtering the radiographic image to obtain an edge-enhanced image. The method also includes clustering image pixels of the edge-enhanced image of the tooth to identify enamel, dentine, pulp and caries layers of the tooth and comparing at least one of the entropy, angular second moment, contrast, inverse different moment, cluster tendency index and cluster shade index parameters for each of the identified enamel, dentine, pulp and caries layers with corresponding parameters of respective layers of a reference image to detect the caries on the tooth.

In accordance with another aspect, a system for detecting caries on a tooth is provided. The system includes a memory circuit configured to store a radiographic image of the tooth and reference parameters and an image processing circuit configured to process the radiographic image to identify enamel, dentine, pulp and caries layers of the tooth and to detect caries on the tooth based upon at least one texture parameter of the enamel, dentine, pulp and caries layers of the tooth and the reference parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is an example system for detecting caries on a tooth.

FIG. 2 is an example flow diagram of an embodiment of a method for detecting caries on a tooth using the system of FIG. 1.

FIG. 3 illustrates example images generated by image processing of a radiographic image of a tooth using the system of FIG. 1.

FIG. 4 is a table with example values of texture parameters for a caries affected tooth.

FIG. 5 is a table with example values for estimated sum of square distance obtained by comparing texture parameters for an image with reference parameters of a reference image.

FIG. 6 is a block diagram illustrating an example computing device that is arranged for detecting caries on a tooth.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Example embodiments are generally directed to detection of dental cavities. A dental cavity is also known as a dental caries or tooth decay. The technique provides an automated diagnostic system that processes radiographic images of the tooth and detects dental caries using image segmentation and classification, as will be described in detail below.

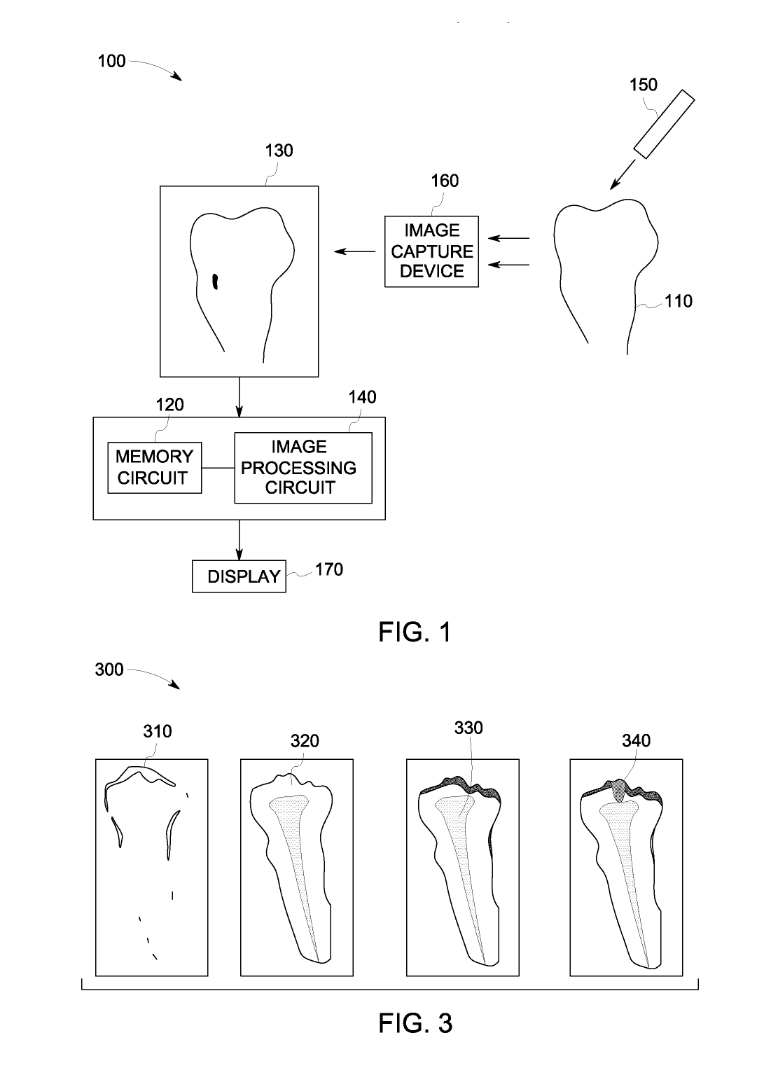

Referring now to FIG. 1, an example system 100 for detecting caries on a tooth 110 is illustrated. As used herein, the term “caries” refers to a decay of tooth structure caused by bacteria and other environmental factors. Examples of forms of caries include but are not limited to holes, grooves, pin point depressions and cracks in the tooth structure. As illustrated, the system 100 includes a memory circuit 120 configured to store a radiographic image 130 of the tooth 110. The memory circuit 120 is further configured to store reference parameters. In one embodiment, the reference parameters include texture parameters of different layers of tooth of a reference image. It should be borne in mind that, although a single memory circuit is described here, the memory storing function may be performed by more than one memory device associated with the system for storing analysis routines, reference parameters, and so forth.

The memory circuit 120 may include hard disk drives, optical drives, tape drives, random access memory (RAM), read-only memory (ROM), programmable read-only memory (PROM), redundant arrays of independent disks (RAID), flash memory, magneto-optical memory, holographic memory, bubble memory, magnetic drum, memory stick, Mylar® tape, smartdisk, thin film memory, zip drive, and so forth.

Referring again to FIG. 1, the system also includes an image processing circuit 140 configured to process the radiographic image 130 to identify enamel, dentine, pulp and caries layers of the tooth 110 and to detect caries on the tooth 110 based upon at least one texture parameter of the enamel, dentine, pulp and caries layers of the tooth 110 and the reference parameters. In the illustrated embodiment, the system 100 includes an X-ray generator 150 for illuminating the tooth 110 and an image capture device 160 configured to capture the radiographic image 130 of the tooth. Image capture may be performed by using any suitable illumination device and other imaging optics arrangement with possible configurations ranging from a single lens component to a multi-element lens. Examples of image capture device 160 include, but are not limited to, dental radio visual graphy equipment(RVG), intraoral dental x-ray unit and dental orthopantomography x-ray system

In operation, the X-ray generator 150 directs incident light at a suitable wavelength and energy level (e.g., X-rays) towards the tooth 110 to generate the radiographic image 130 which is acquired by the image capture device 160. In certain embodiments, the image capture device 160 includes a monochrome camera or a color camera, or a conventional film. It should be noted that the radiographic images 130 of the tooth 110 may be pre-generated and stored in the memory circuit 120. Further, such images 130 may be accessed by the image processing circuit 140 to detect the caries on the tooth 110. In this embodiment, the system 100 also includes a display 170 for displaying the processed image with the detected caries on the tooth 110. Where conventional film is used, the resulting images may be digitized for analysis in accordance with the teachings provided in this disclosure.

The image processing circuit 140 is configured to cluster image pixels of the radiographic image 130 to identify the enamel, dentine, pulp and caries layers of the tooth 110. In certain embodiments, the radiographic image 130 is high-pass filtered to enhance edge details of the image 130. In one example embodiment, the image processing circuit 140 includes a second order Butterworth high-pass filter to filter the radiographic image 130. In this embodiment, a radius of filter cut-off frequency of the Butterworth high-pass filter is about 0.01.

In this example embodiment, the image processing circuit 140 employs C-means clustering for clustering the image pixels. However, other clustering techniques such as K-means clustering and fuzzy C-means clustering may be employed for clustering the image pixels.

Further, the image processing circuit 140 is configured to estimate at least one texture parameter for the enamel, dentine, pulp and caries layers using co-occurrence matrices. In this embodiment, the image processing circuit 140 utilizes gray level co-occurrence matrices (GLCM) to extract second order statistics from the radiographic image 130 for texture classification and estimation of texture parameters. As used herein, the term “gray level co-occurrence matrix” of an image is defined as a matrix of frequencies at which two pixels, separated by a certain vector, occur in the image.

In an embodiment, the distribution of the GLCM matrix depends on the angular and spatial relationship between pixels. Once the GLCM has been obtained, it can be used to compute texture parameters like entropy, angular second moment, contrast, inverse different moment, cluster tendency and cluster shade.

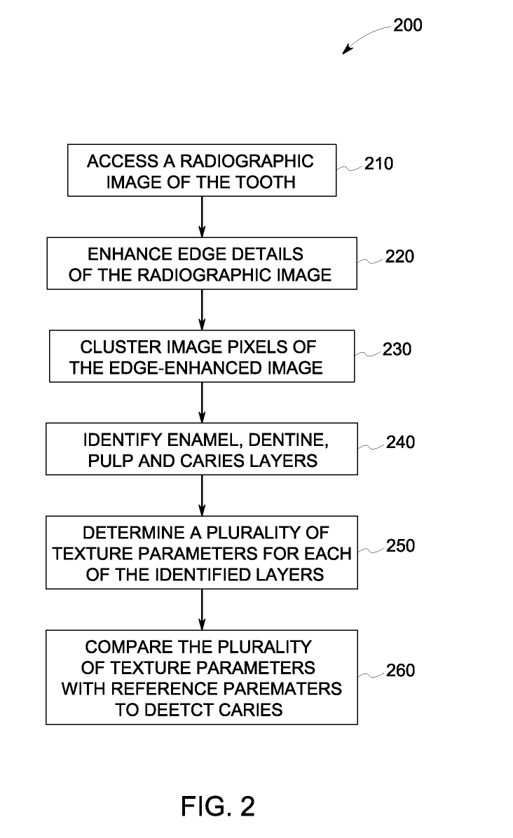

In an embodiment, the texture parameters obtained from the GLCM are utilized to classify and differentiate the caries from other tooth layers. In this example embodiment, the texture parameters are estimated separately for each of the enamel, dentine, pulp and caries layers. The image processing circuit 140 is configured to estimate a sum of square distance based upon the at least one texture parameter for each of the identified enamel, dentine, pulp and caries layers and the reference parameters. The caries on the tooth are subsequently differentiated from the other layers of the tooth based upon the estimated sum of square distance. The clustering of the image pixels and estimation of texture parameters from the radiographic image 130 will be described below with reference to FIGS. 2-5. Also, while reference is made to reference parameters of an image, it should be borne in mind that such reference parameters may, in practice, be based upon a group of images or image data that provide a reliable indication of the presence of caries.

FIG. 2 illustrates an example flow diagram 200 of an embodiment of a method for detecting caries on a tooth using the system 100 of FIG. 1. At block 210, a radiographic image of the tooth is accessed. Further, the edge details of the radiographic image are enhanced by high-pass filtering the image (block 220). The high-pass filtering can reduce random and structured noise in the image data and can enhance the quality of the image. In this embodiment, frequency domain filters are employed to transfer the accessed image into frequency domain and to separate the various tooth layers like enamel, dentine and pulp layers using edge details of the processed image. In one embodiment, a Butterworth high-pass filter is employed to enhance the edge details of the image. Examples of other filters include, but are not limited to, Chebyshev filter, Gaussian filter and elliptic filter.

In an example embodiment, the high pass filtered image transformed in a frequency domain may be represented by the following equation:

G(u,v)=H(u,v),F(u,v) (1)

Where:
F(u,v) is the Fourier transform of the input;
H(u,v) is filter transfer function; and
G(u,v) is the filtered image.

The transfer function of a Butterworth high pass filter of order ‘n’ with cut off frequency locus at a distance D₀ from the origin is represented by the following equation:

$$H ( u , v ) = \frac{1}{1 + {[ \frac{{D}_{0}}{D ( u , v )} ]}^{2 n}} \qquad ( 2 )$$

Where: D₀ is the specified nonnegative quantity; and

D(u, v) is the distance from point (u, v) to the origin of the frequency plane; that is represented by the following equation:

D(u,v)=(u²+v²)^{1/2} (3)

The filtered image using the filter described above yields a sharpened edge-enhanced image that is further processed for identifying the various layers of the tooth.

Once the edge-enhanced image is generated, the image pixels having similar pixel intensities are labeled with a gray level or a color and the labeled pixels are assigned to the enamel, dentine, pulp and caries layers based upon pre-determined thresholds for each of the enamel, dentine, pulp and caries layers. In the illustrated embodiment, the tooth image is scanned and the pixels are grouped into components based on pixel connectivity wherein all pixels in a connected component have similar pixel intensity values.

In an embodiment, after the scan is completed, the equivalent label pairs are sorted into equivalent classes and a unique label is assigned to each layer. In certain embodiments, a second scan of the image may be performed, during which each label is replaced by the label assigned to its equivalent layers. Further, the labeled pixels in the image are grouped into enamel, dentine and pulp layers based upon pre-determined thresholds.

At block 230, image pixels of the edge-enhanced image are clustered to identify the enamel, dentine, pulp and caries layers (block 240). A plurality of clustering techniques may be employed for clustering of the image pixels. Examples of such techniques include, but are not limited to, C-means clustering, K-means clustering and fuzzy C-means clustering. In the illustrated embodiment, C-means clustering is utilized for clustering which minimizes the total of the distances between the prototypes and the objects by construction of a target function.

The technique includes an initial partition matrix (U) that is used to estimate input values for the number of classes, iteration tolerance and the centers of clusters (classes). Subsequently, the membership values that each data point has in the cluster are recalculated using the center of clusters. Such values are compared with assumed values and this process is continued until the changes from cycle to cycle are within the prescribed tolerance level.

In this embodiment, the sum of squared errors approach using Euclidean norm is applied to characterize the distance within a class. The objective function algorithm is denoted as J(U,v) where U is the partition matrix and the parameter, v is a vector of cluster centers. The objective function is represented by the following relationship:

$$J ( U , v ) = {\sum }_{k = 1}^{n} {\sum }_{i = 1}^{c} {{x}_{ik} ( {d}_{ik} )}^{2} \qquad ( 4 )$$

Where: dᵢₖ is a Euclidean distance measure (in m-dimensional feature space, R^{m}) between the k^{th} data sample xₖ and i^{th} cluster center vᵢ; and

$${d}_{ik} = d ( {x}_{k} - {v}_{i} ) = ‖ {x}_{k} - {v}_{i} ‖ = {[ {\sum }_{j = 1}^{m} {( {x}_{kj} - {v}_{ij} )}^{2} ]}^{\frac{1}{2}} \qquad ( 5 )$$

Initially, the number of classes (c) and the number of objects (A), and a weighting factor m is selected where 1<m<∞. Further, the center vectors are estimated using the following relationship:

$${v}_{ij} = \frac{{\sum }_{k = 1}^{n} {x}_{ik} {x}_{kj}}{{\sum }_{k = 1}^{n} {x}_{ik}} \qquad ( 6 )$$

Further, the U^{(r)} matrix is updated by calculating the updated characteristic functions (for all i, k) using the following equation:

$${x}_{ik}^{r + 1} = \{ \begin{matrix}1 & {d}_{ik}^{r} = min \{ {d}_{jk}^{r} \} for all j ∈ c \\ 0 & otherwise\end{matrix} \} \\ If ‖ {U}^{( r + 1 )} - {U}^{r} ‖ <= ɛ ( tolerance level ) \\ then the process is completed , otherwise the value \qquad ( 7 )$$

of r is incremented (r=r+1) and the process is repeated to achieve the desired tolerance level.

At block 250, a plurality of texture parameters are determined for each of the identified dentine, enamel, pulp and caries layers. The texture parameters facilitate accurate image segmentation by quantifying the homogeneity and consistency of tissues across the radiographic image. In this example embodiment, co-occurrence matrices are used in the textural analysis of the image. In the illustrated embodiment, texture parameters such as entropy, angular second moment, contrast, inverse different moment, cluster tendency and cluster shade are computed from gray level co-occurrence matrices (GLCM) of the identified dentine, enamel, pulp and caries layers.

In certain embodiments, different colors are assigned to identified layers of the tooth to permit visualization of the layers. In particular, colors are assigned to monochrome images based on various properties of their gray level content of tooth layers. In this example embodiment, a plurality of planes may be disposed parallel to a co-ordinate plane of the image wherein each plane slices the image to identify different layers based upon an area of intersection. Subsequently, different colors are assigned to each layer. This pseudo coloring of the various layers facilitates identification of any discontinuity in the tooth pattern by increasing the distance in color space between successive gray levels.

At block 260, the plurality of texture parameters are compared with reference parameters to detect the caries on the tooth. In one example embodiment, the plurality of texture parameters for each of the enamel, dentine, pulp and caries layers are compared with corresponding parameters of respective layers of a reference image. The parameters for the layers of the reference image may be separately measured and stored. In this example embodiment, a sum of square distance is estimated based upon the plurality of texture parameters and the reference parameters and the caries is detected based upon the estimated sum of square distance. In certain embodiments, a depth of the caries is determined by measuring a number of pixels in the caries layer.

FIG. 3 illustrates example images 300 generated by image processing of a radiographic image of a tooth using the system 100 of FIG. 1. In this embodiment, a single tooth from a dental X-ray image is isolated and is digitized to an average size of about 128×64 pixels. Further, radiological difference between the enamel, dentine, pulp and caries layers represented by reference numerals 310, 320, 330 and 340 is assessed using contrast variation of the various layers. This input X-ray image of the tooth is then preprocessed to enhance the edges to make the enamel 310, dentine 320, pulp 330 and caries 340 layers distrainable. Further, the pixels of the resultant image are labeled and the tooth layers are classified into enamel 310, dentine 320, pulp 330 and caries 340 layers using C-means clustering.

As described before, the labeled image pixels are assigned to different layers based upon pre-determined thresholds for each of the layers. In certain embodiments, the segmented layers 310, 320, 330 and 340 may be assigned different colors to facilitate visualization of the individual layers 310, 320, 330 and 340.

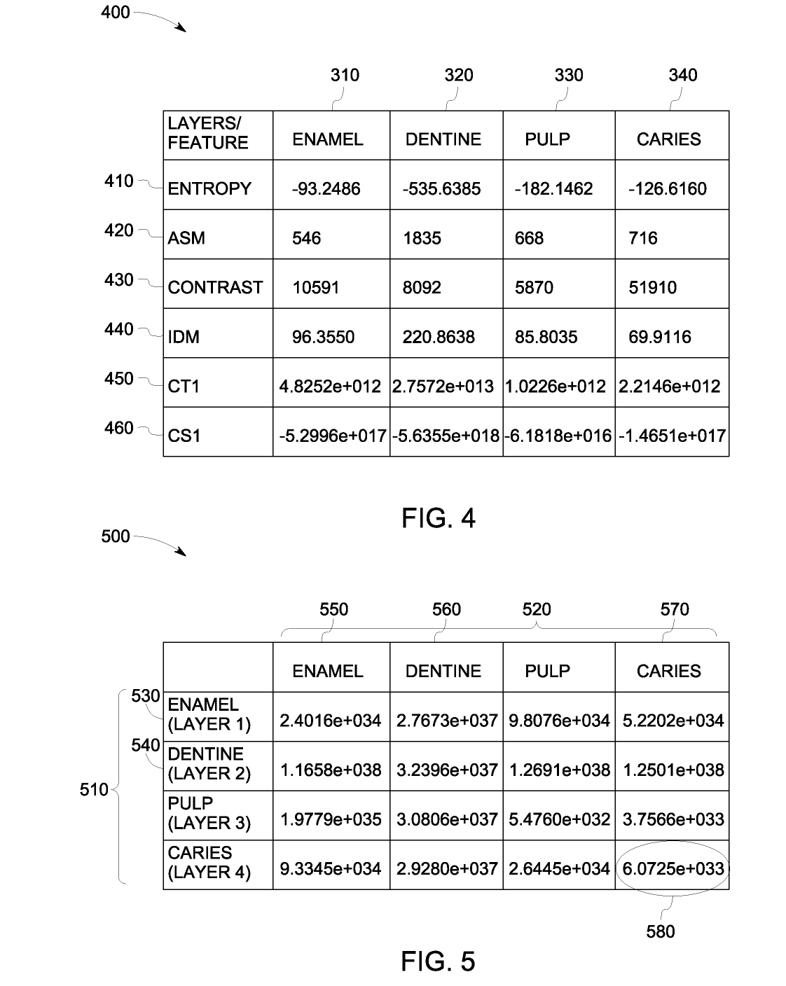

Further, texture parameters are extracted from the co-occurrence matrices of the segmented layers 310, 320, 330 and 340 of the tooth image can be obtained through C-means clustering. Example values of texture parameters for a caries affected tooth are shown in table 400 of FIG. 4. As illustrated, texture parameters such as the entropy 410, angular second moment (ASM) 420, contrast 430, inverse different moment (IDM) 440, cluster tendency (CT1) 450 and cluster shade (CS1) 460 are estimated for each of the enamel, dentine, pulp and caries layers 310, 320, 330 and 340. In one embodiment, these parameters correspond to a reference image of a tooth. Each of these parameters may be compared to corresponding parameters of respective layers of a test image to detect caries on the tooth.

In another embodiment, the texture features 400 of the image are compared with reference parameters to estimate the sum of squared distance. FIG. 5 shows example values for estimated sum of square distance obtained by comparing texture parameters 510 for an image with reference parameters 520 of a reference image. As illustrated, the sum of square distance is estimated by comparing texture parameters 530 and 540 of layers such as enamel and dentine layers with reference parameters 550 and 560 of corresponding layers of the reference image. Further, the sum of square distance is also estimated by comparing texture parameters 530 of layer such as the enamel layer with reference parameters 570 of a different layer such as the caries layer.

In an example embodiment, the sum of square distance estimated by comparing texture parameters with reference parameters of corresponding layers of the reference image results in a minimum sum of square distance value. In this example embodiment, the texture parameters for the caries layer of the image compared with the reference parameters of the caries layer of the reference image results in the minimum value of the sum of square distance, as represented by reference numeral 580. This value of the sum of square distance 580 can facilitate detection of the carious lesion in the tooth.

The example methods and systems described above enable detection of caries on the tooth. The methods and systems discussed herein utilize an efficient, reliable, and cost-effective technique for performing diagnostic segmentation and classification to identify dental caries and to assess the extent of the caries lesion in the tooth. Such automated diagnostics aid a dentist in the assessment, treatment planning and evaluation of oral diseases such as dental caries. The technique provides complete information about the tooth including estimates of caries intrusion, even in root canals with extreme apical curvatures thereby increasing the diagnostic ease of the dental surgeon.

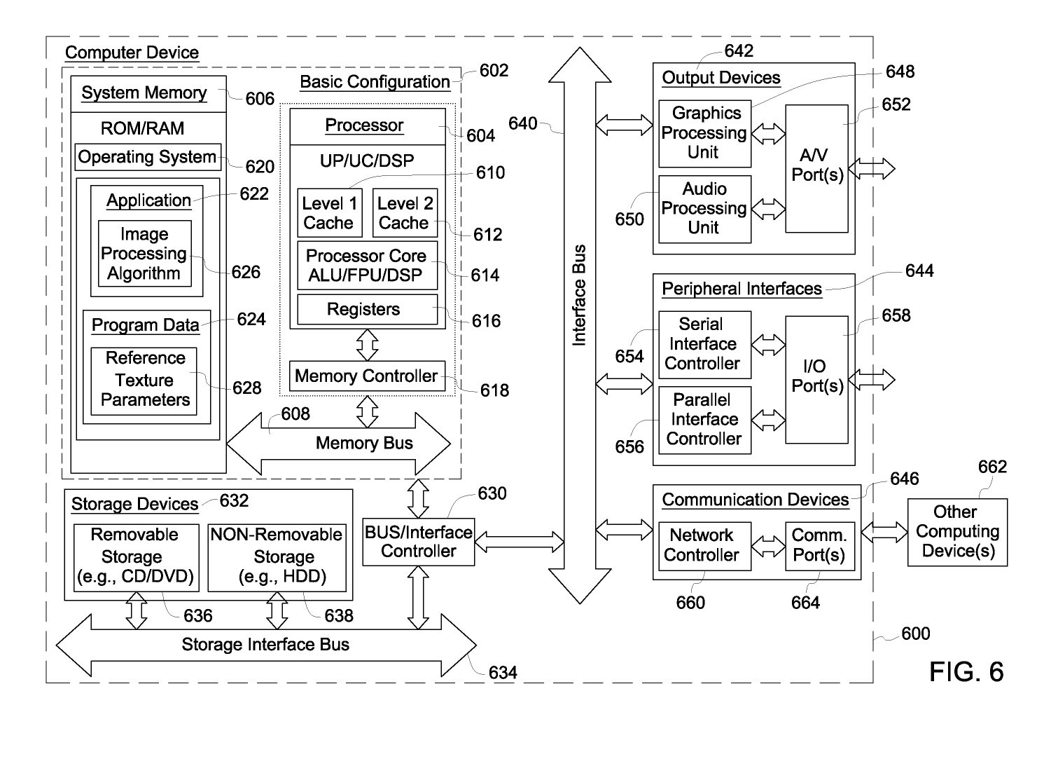

FIG. 6 is a block diagram illustrating an example computing device 600 that is arranged for detecting caries on a tooth in accordance with the present disclosure. In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include an image processing algorithm 626 that is arranged to perform the functions as described herein including those described with respect to process 200 of FIG. 2. Program data 624 may include reference texture parameters 628 that may be useful for detecting the caries as is described herein. In some embodiments, application 622 may be arranged to operate with program data 624 on operating system 620 such that determination of the quotient values based upon the intermediate remainder value may be performed. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for detecting caries on a tooth, comprising:
clustering image pixels of an edge-enhanced image of the tooth to identify enamel, dentine, pulp and caries layers of the tooth;
determining a plurality of texture parameters for each of the identified enamel, dentine, pulp and caries layers; and
comparing the plurality of texture parameters with reference parameters to detect caries on the tooth.

2. The method of claim 1, further comprising:
accessing a radiographic image of the tooth;
high-pass filtering the radiographic image of the tooth to generate the edge-enhanced image; and
labeling the image pixels having similar pixel intensities with a gray level or a color and assigning the labeled image pixels to the enamel, dentine and pulp layers based upon pre-determined thresholds for each of the enamel, dentine and pulp layers.

3. The method of claim 2, wherein high-pass filtering comprises applying high-pass Butterworth filter to the radiographic image for enhancing edge details of the image.

4. The method of claim 1, comprising clustering the image pixels via C-means clustering and determining the plurality of texture parameters using gray level co-occurrence matrices of the layers of the edge-enhanced image.

5. The method of claim 4, wherein the plurality of texture parameters comprise entropy, or angular second moment, or contrast, or inverse different moment, or cluster tendency index, or cluster shade index, or combinations thereof.

6. The method of claim 1, further comprising assigning different colors to identified layers of the tooth for to permit visualization of the layers.

7. The method of claim 1, wherein comparing the plurality of texture parameters comprises:
estimating a sum of squared distance based upon the plurality of texture parameters and the reference parameters; and
detecting the caries based upon the estimated sum of squared distance.

8. The method of claim 1, further comprising determining a depth of the caries by measuring a number of pixels in the caries layer.

9. A method for detecting caries on a tooth, comprising:
accessing a radiographic image of the tooth;
high-pass filtering the radiographic image to obtain an edge-enhanced image;
clustering image pixels of the edge-enhanced image of the tooth to identify enamel, dentine, pulp and caries layers of the tooth; and
comparing at least one of the entropy, angular second moment, contrast, inverse different moment, cluster tendency index and cluster shade index parameters for each of the identified enamel, dentine, pulp and caries layers with corresponding parameters of respective layers of a reference image to detect the caries on the tooth.

10. The method of claim 10, wherein clustering image pixels comprises labeling the image pixels having similar pixel intensities with a gray level or a color and assigning the labeled image pixels to the enamel, dentine and pulp layers.

11. The method of claim 10, further comprising estimating a sum of square distance based upon the at least one of the entropy, angular second moment, contrast, inverse different moment, cluster tendency index and cluster shade index parameters for each of the identified enamel, dentine, pulp and caries layers.

12. The method of claim 12, further comprising comparing the estimated sum of square distance for each of the enamel, dentine, pulp and caries layers with sum of square distance of corresponding layer of the reference image.

13. A system for detecting caries on a tooth, comprising:
a memory circuit configured to store a radiographic image of the tooth and reference parameters; and
an image processing circuit configured to process the radiographic image to identify enamel, dentine, pulp and caries layers of the tooth and to detect caries on the tooth based upon at least one texture parameter of the enamel, dentine, pulp and caries layers of the tooth and the reference parameters.

14. The system of claim 13, wherein the image processing circuit is configured to cluster image pixels of the radiographic image via C-means clustering and to estimate the at least one texture parameters using gray level co-occurrence matrices of each of the enamel, dentine, pulp and caries layers.

15. The system of claim 13, wherein the system comprises:
a X-ray generator for illuminating the tooth; and
an image capture device to capture the radiographic image of the tooth.

16. The system of claim 13, wherein the texture parameter comprises entropy, angular second moment, contrast, inverse different moment, cluster tendency index and cluster shade index.

17. The system of claim 13, wherein the image processing circuit is configured to:
estimate a sum of square distance based upon the at least one texture parameter for each of the identified enamel, dentine, pulp and caries layers and the reference parameters; and
differentiate the caries on the tooth based upon the estimated sum of square distance.

18. The system of claim 13, wherein the image processing circuit comprises a second order Butterworth high-pass filter configured to enhance edge details of the radiographic image.

19. The system of claim 18, wherein a radius of filter cutoff frequency of the Butterworth high-pass filter is about 0.01.

20. The system of claim 13, further comprising a display for displaying the processed image with the detected caries on the tooth.
